(19) United States
(12) Patent Application Publication
(10) Pub. No.: US 2020/0401084 A1
(43) Pub. Date: Dec. 24, 2020

(54) Method of Constructing a Wall Clock using Vinyl Records

(71) Applicants: Oleg Melnychuk, Lutsk (UA); Taras Melnyk, Lutsk (UA)

(72) Inventors: Oleg Melnychuk, Lutsk (UA); Taras Melnyk, Lutsk (UA)

(21) Appl. No.: 16/739,708

(22) Filed: Jan. 10, 2020

Related U.S. Application Data
(60) Provisional application No. 62/864,386, filed on Jun. 20, 2019.

(51) Int. Cl. G04B 45/00; G11B 3/58

(52) U.S. Cl. CPC G04B 45/0076; G04B 45/0015; G11B 2220/20; G11B 3/58; G04B 45/0069

(57) ABSTRACT

A method of constructing a wall clock using vinyl records allows a vinyl record to be recycled and repurposed as a wall clock. A used vinyl record is refurbished by being polished and buffed to respectively improve shine and remove any scratches. Track information and/or other designs are engraved onto the vinyl record for aesthetic purposes. A central portion of the vinyl record is modified into a clock-receiving setting in order to receive a center piece. The center piece is the display face of a wall clock. The center piece is mounted into the clock-receiving setting. A clock mechanism is mounted onto the center piece, opposite the clock-receiving setting. The clock mechanism may be any type of mechanism in order produce a clock movement for a wall clock. The clock mechanism includes a pair of clock hands to allow an individual to tell time from the constructed wall clock.

The current application claims a priority to the U.S. Provisional Patent application Ser. No. 62/864,386 filed on Jun. 20, 2019.

### FIELD OF THE INVENTION

The present invention generally relates to ornamental decorations and methods of making ornamental decorations. More specifically, the present invention relates to vinyl record wall clocks and methods of making the vinyl record wall clocks from recycled vinyl records.

### BACKGROUND OF THE INVENTION

An objective of the present invention is to provide vinyl record wall clocks made from used vinyl records as basis for future decorations. The present invention helps recycle used vinyl records into nice decorations to reduce waste from used vinyl records. Prior art provides vinyl clocks made from whole vinyl records without laser-cut designs. On the other hand, the present invention provides laser-cut designs on the vinyl record to customize each clock. In addition, the method of the present invention includes varnishing the vinyl record wall clock to have the perfect shine.

The method of production of the vinyl record wall clock comprises several stages. First, the vinyl record is inspected for scratches or other physical damages. Due to the nature of used vinyl records, the first stage is very important to guarantee proper time design on the vinyl records. In addition, the clock designed is chosen by the customer and generated by a professional designer. The next step involves applying the chosen design to the used vinyl record. The design is preferably cut out on the used vinyl record by a laser cutting machine. The laser cutting machine facilitates smooth lines which makes the vinyl record wall clock have a 3D appearance. After the design is applied to the used vinyl record, the cut vinyl record is cleaned, polished, and varnished. Lacquering the upside of the cut vinyl record provides additional protection to the surface of the vinyl plate. Finally, a vinyl sticker is attached to the cut vinyl record as well as a clock mechanism. The customer can change the color scale of the clock face sticker and make any adjustments to its design. In further embodiments of the present invention, the vinyl sticker can be replaced with a thin plate preferably made of Aluminum. Additional features can be applied to the vinyl record wall clock.

### BRIEF DESCRIPTION OF THE DRAWINGS

FIG. 1 is a flowchart illustrating the overall process of the method.

FIG. 2 is a flowchart illustrating a subprocess of refurbishing the vinyl record.

FIG. 3 is a flowchart illustrating another subprocess of refurbishing the vinyl record.

FIG. 4 is a flowchart illustrating a subprocess of modifying the central portion of the vinyl record into the clock-receiving setting.

FIG. 5 is a flowchart illustrating a subprocess of customizing the center piece.

FIG. 6 is a flowchart illustrating another subprocess of customizing the center piece.

FIG. 7 is a flowchart illustrating a subprocess of engraving track information onto the vinyl record.

### DETAIL DESCRIPTIONS OF THE INVENTION

All illustrations of the drawings are for the purpose of describing selected versions of the present invention and are not intended to limit the scope of the present invention.

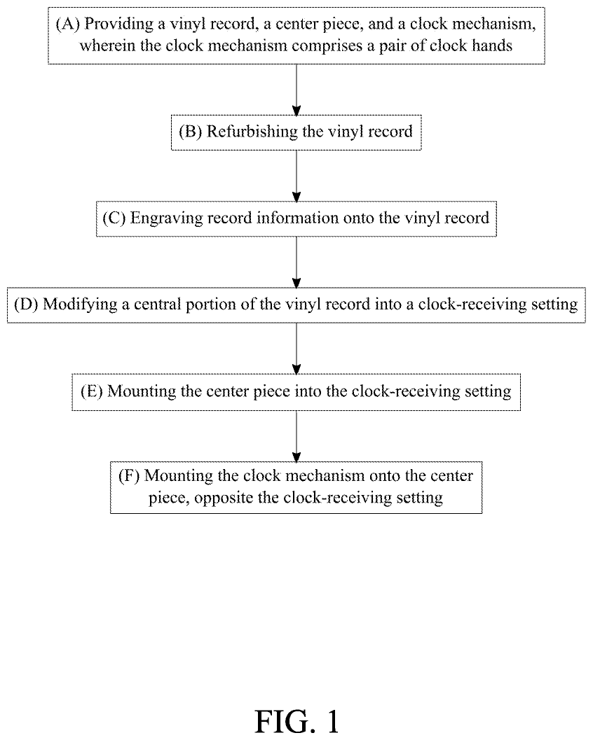

In reference to FIGS. 1 through 7, the present invention is a method of constructing a wall clock using vinyl records that allows a used vinyl record to be recycled and repurposed as a wall clock for an aesthetic decoration. A vinyl record, a center piece, and a clock mechanism are provided for the overall process (Step A). The vinyl record is preferably a used vinyl record. The center piece is the display face of a wall clock. The center piece may include any design which can be chosen by a consumer. The clock mechanism may be any type of mechanism that enables the clockwork movement of a wall clock. Moreover, the clock mechanism comprises a pair of clock hands. The pair of clock hands is powered by the clock mechanism in order to display the current time.

The method of the present invention follows an overall process that allows a vinyl record to be recycled and repurposed as a wall clock. With reference to FIG. 1, the vinyl record is refurbished (Step B). This step restores the vinyl record into a new-like condition. Record information is engraved onto the vinyl record (Step C). Record information is preferably information exclusive to the vinyl record chosen by the consumer. For example, the record information may be the names of the tracks that could have been or can be played by the vinyl record. A central portion of the vinyl record is modified into a clock-receiving setting (Step D). The clock-receiving setting is an aperture that prepares the vinyl record to receive the center piece. The center piece is mounted into the clock-receiving setting (Step E). Thus, the center piece is secured into the vinyl record in order to display the face of a wall clock. Lastly, the clock mechanism is mounted onto the center piece, opposite the clock-receiving setting (Step F). This step fully enables the clockwork movement for the center piece and thus allows the vinyl record to be used as a wall clock.

The center piece is preferably made of an aluminum material for rigidity and aesthetics. Further and similarly to the center piece, the pair of clock hands is made of an aluminum material for rigidity and aesthetics. The use of aluminum material is better for a wall clock than the use of paper material. Moreover, the use of aluminum material makes the center piece and the pair of clock hands more resistant to sunlight burnout, dampness, and/or scratches.

A power system and a clock control are integrated into the clock mechanism without affecting the design of the vinyl record. A plurality of numbers and/or indicia is integrated into the vinyl record and/or the center piece according to the overall design of the clock wall constructed from the overall process. Further, the plurality of number indicators corresponds to the clock hands. The clock mechanism can comprise various types and methods of operation. In the preferred embodiment, the clock mechanism is 555 timer driven. In other terms, the clock mechanism comprises a clock movement type 5168S. A 555-clock movement allows a wall clock to accurately display the time down to microseconds.

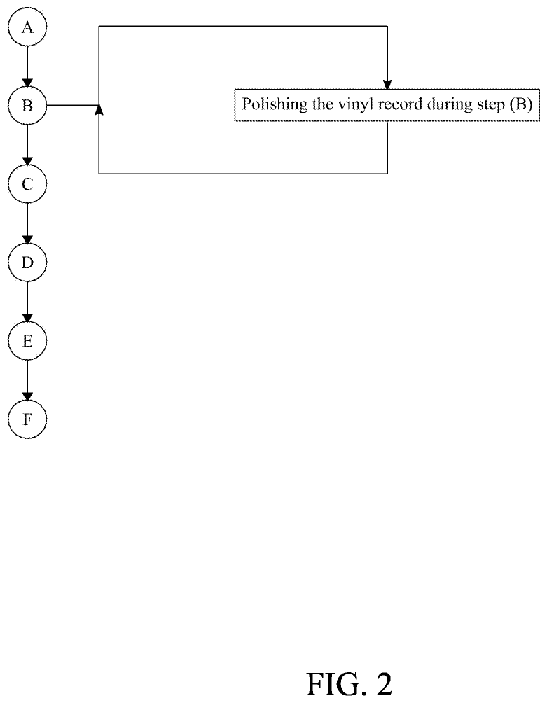

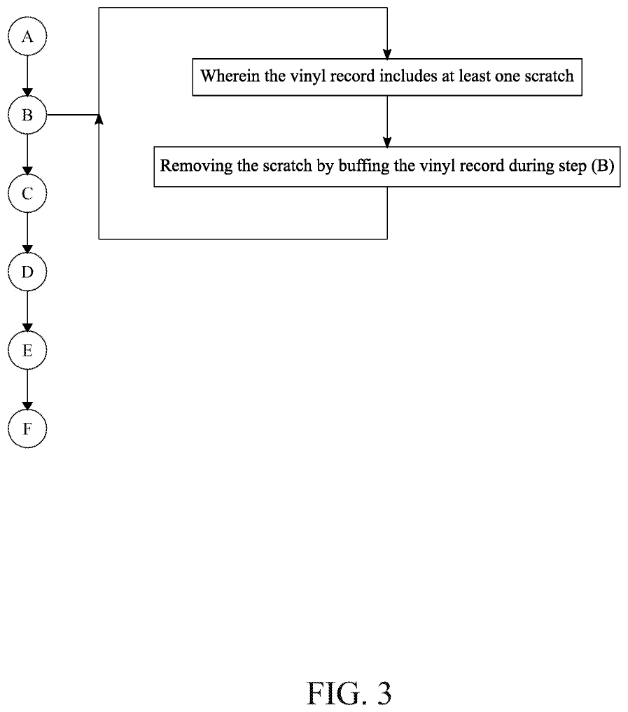

As mentioned previously, used vinyl records are preferably used for constructing a wall clock. Used vinyl records lack the original shine from when the vinyl record was brand new. The vinyl record is inspected for lack of shine. If the vinyl record lacks shine and with reference to FIG. 2, the vinyl record is polished during Step B in order to reestablish the shine of the vinyl record. Furthermore, used vinyl records may be damaged with scratches. The vinyl record is inspected for physical damage or defects. With reference to FIG. 3, the vinyl record may include at least one scratch. Due to this, the vinyl record is buffed in order to remove the scratch during Step B. Thus, the vinyl record is properly refurbished in order to restore the vinyl record to a new-like condition.

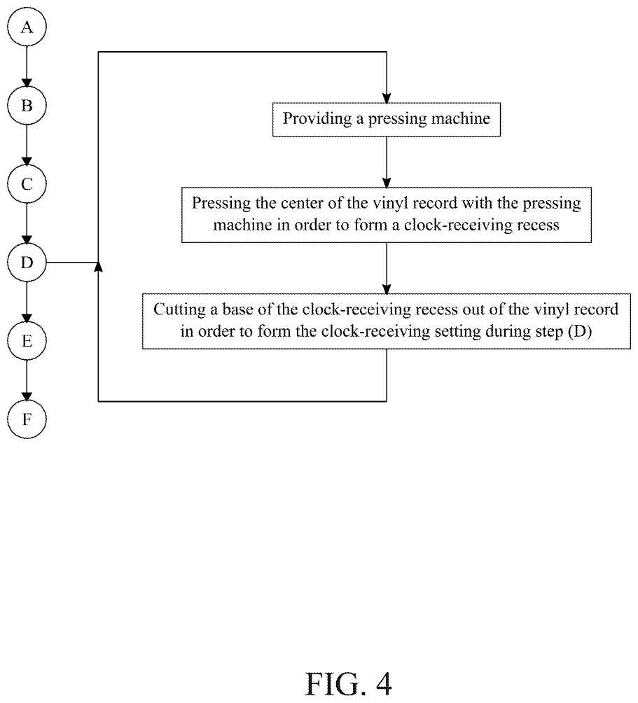

With reference to FIG. 4, a specific subprocess if used to modify the central portion of the vinyl record into the clock-receiving setting. A pressing machine is provided. The pressing machine is a machine used for the modification of the vinyl record. The center of the vinyl record is pressed with the pressing machine in order to form a clock-receiving recess. This step prepares the vinyl record to be modified to receive the center piece. A base of the clock-receiving recess is cut out of the vinyl record in order to form the clock-receiving setting during Step D. Thus, the vinyl record is able to receive the center piece.

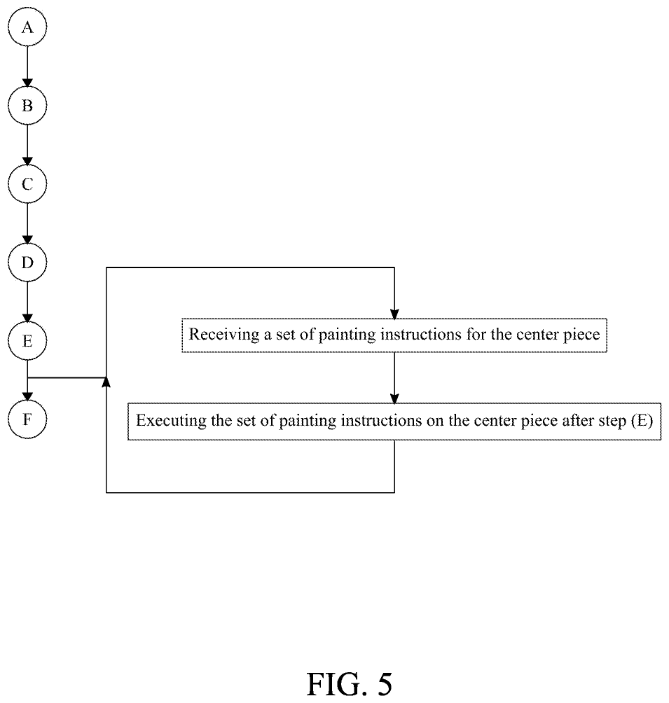

The design of the center piece may be customized by the consumer before construction of the wall clock. In further detail and with reference to FIG. 5, a set of painting instructions is received for the center piece. The set of painting instructions may be a color or design chosen by a consumer for the center piece. The set of painting instructions is executed on the center piece after Step E. Thus, the design of the center piece is chosen by the consumer.

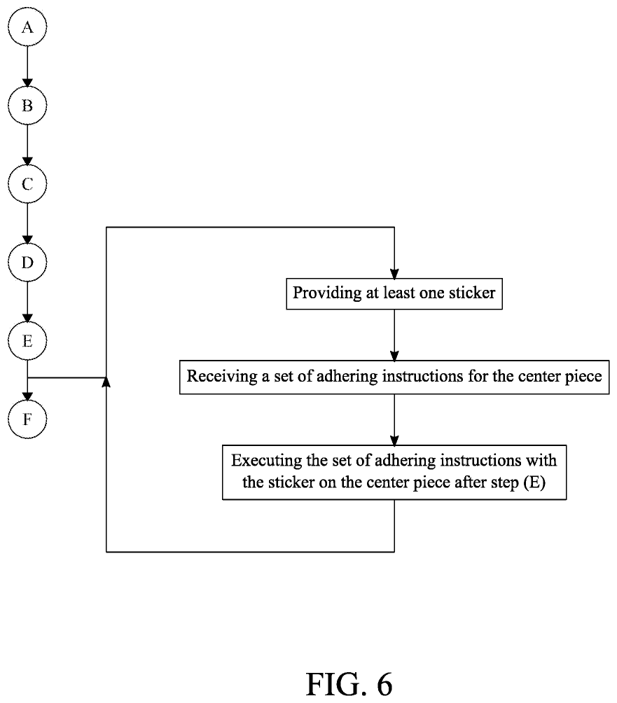

Along with the design of the center piece and with reference to FIG. 6, the consumer may also choose if a sticker(s) is placed on the center piece and the type of sticker. Thus, at least one sticker is provided. The sticker may be an adhesive decoration for the center piece. A set of adhering instructions is received for the center piece. The set of adhering instructions may be instructions for a specific quantity and type of stickers to be adhered onto the center piece. The set of adhering instructions with the sticker is executed on the center piece after Step E. Thus, the consumer can choose if a sticker(s) is adhered on the center piece and the type of sticker.

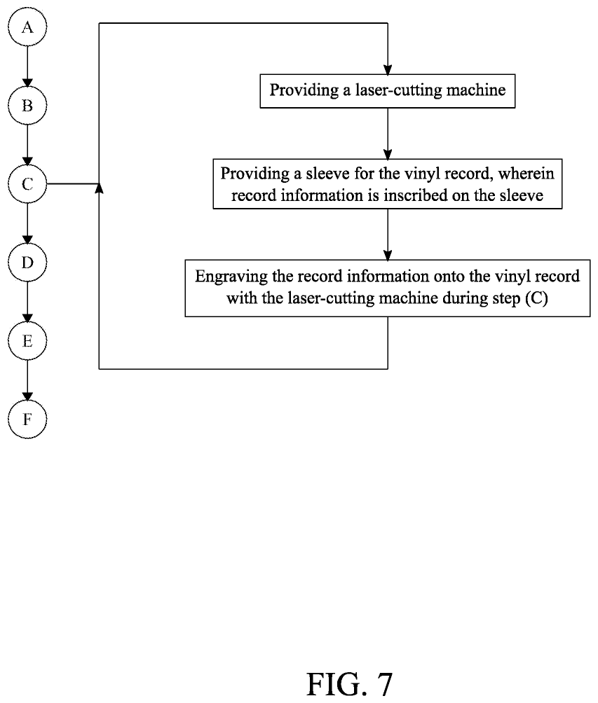

With reference to FIG. 7, the vinyl record may be modified for aesthetic purposes. A laser-cutting machine is provided for the modification of the vinyl record. For example, the laser-cutting machine may be used to etch a consumer-desired design into or onto the vinyl record. A sleeve is provided for the vinyl record. The sleeve is the original packaging of the vinyl record. Record information may be inscribed on the sleeve. In the particular case of the present invention, the laser-cutting machine engraves the record information onto the vinyl record during Step C. Thus, the vinyl record is modified for aesthetic purposes.

Although the invention has been explained in relation to its preferred embodiment, it is to be understood that many other possible modifications and variations can be made without departing from the spirit and scope of the invention as hereinafter claimed.

What is claimed is:

1. A method of constructing a wall clock using vinyl records, the method comprises the steps of:
(A) providing a vinyl record, a center piece, and a clock mechanism, wherein the clock mechanism comprises a pair of clock hands;
(B) refurbishing the vinyl record;
(C) engraving record information onto the vinyl record;
(D) modifying a central portion of the vinyl record into a clock-receiving setting;
(E) mounting the center piece into the clock-receiving setting; and
(F) mounting the clock mechanism onto the center piece, opposite the clock-receiving setting.

2. The method of constructing a wall clock using vinyl records, the method as claimed in claim 1, wherein the center piece is made of an aluminum material.

3. The method of constructing a wall clock using vinyl records, the method as claimed in claim 1, wherein the pair of clock hands is made of an aluminum material.

4. The method of constructing a wall clock using vinyl records, the method as claimed in claim 1, wherein the clock mechanism is 555 timer driven.

5. The method of constructing a wall clock using vinyl records, the method as claimed in claim 1 comprises the step of:
polishing the vinyl record during step (B).

6. The method of constructing a wall clock using vinyl records, the method as claimed in claim 1 comprises the step of:
wherein the vinyl record includes at least one scratch; and
removing the scratch by buffing the vinyl record during step (B).

7. The method of constructing a wall clock using vinyl records, the method as claimed in claim 1 comprises the steps of:
providing a pressing machine;
pressing the center of the vinyl record with the pressing machine in order to form a clock-receiving recess; and
cutting a base of the clock-receiving recess out of the vinyl record in order to form the clock-receiving setting during step (D).

8. The method of constructing a wall clock using vinyl records, the method as claimed in claim 1 comprises the steps of:
receiving a set of painting instructions for the centerpiece; and
executing the set of painting instructions on the center piece after step (E).

9. The method of constructing a wall clock using vinyl records, the method as claimed in claim 1 comprises the steps of:
providing at least one sticker;
receiving a set of adhering instructions for the center piece; and
executing the set of adhering instructions with the sticker on the center piece after step (E).

10. The method of constructing a wall clock using vinyl records, the method as claimed in claim 1 comprises the steps of:
providing a laser-cutting machine;
providing a sleeve for the vinyl record, wherein record information is inscribed on the sleeve; and
engraving the record information onto the vinyl record with the laser-cutting machine during step (C).
